(19) United States
(12) Patent Application Publication
(10) Pub. No.: US 2005/0134719 A1
(43) Pub. Date: Jun. 23, 2005

(54) Display device with automatic area of importance display

(75) Inventor: Susan J. Beck, Holley, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/745,006

(22) Filed: Dec. 23, 2003

(51) Int. Cl. H04N 5/222

(52) U.S. Cl. 348/333.11; 348/240.2

(57) ABSTRACT

Methods for forming an evaluation image for presentation on a display device and display devices adapted to form such evaluation images are provided. An image is obtained having a resolution greater than a resolution of the display and an area of importance automatically determined comprising less than all of the obtained image. Image elements from the area of importance are used to form an area of importance image adapted for presentation on the display; and the area of importance image is presented.

### CROSS-REFERENCE TO RELATED APPLICATIONS

Reference is made to commonly assigned, co-pending U.S. patent application Ser. No. 10/061,385, filed Feb. 1, 2002, entitled SYSTEM AND METHOD OF PROCESSING A DIGITAL IMAGE FOR USER ASSESSMENT OF AN OUTPUT IMAGE PRODUCT, in the name of Fredlund et al.; U.S. Ser. No. 10/324,489, filed Dec. 20, 2002, entitled IMAGING METHOD AND SYSTEM FOR DETERMINING AN AREA OF IMPORTANCE IN AN ARCHIVAL IMAGE, in the name of John R. Fredlund; and U.S. Patent Application Publication No. 2003/0117511A1, filed Dec. 21, 2001, entitled METHOD AND CAMERA SYSTEM FOR BLURRING PORTIONS OF A VERIFICATION IMAGE TO SHOW OUT OF FOCUS AREAS IN A CAPTURED ARCHIVAL IMAGE, in the name of Belz et al., all of which are incorporated herein.

### FIELD OF THE INVENTION

The present invention relates to electronic imaging systems having a display for presenting images.

### BACKGROUND OF THE INVENTION

Hand held and portable display devices are becoming increasingly popular communication tools for capturing, sharing and displaying images that are in digital form. Examples of such devices include digital cameras, hybrid/film electronic cameras, personal digital assistants, digital photo albums, so called e-books, CD and DVD players and the like. Because many consumers prefer display devices that are relatively small, many display devices provide video displays that are also relatively small and therefore such displays have limited image resolution capacity. For example, the image resolving capability of the displays in some of the most popular hand held devices is on the order of 320 picture elements (referred to herein as “pixels”) by 320 pixels. However, it is not uncommon for digital images to be on the order of 2000 pixels by 2000 pixels. Thus, in this respect, portable displays typically have a limited image resolution as compared to the images that they are used to present.

The relatively limited image resolution of such displays requires that image content in a digital image must typically be down sampled to form the evaluation image for presentation on the display. However, the limited image resolution can make it difficult to detect image conditions that can lead to dissatisfaction with a digital image. For example, this down sampling causes an increase in the apparent sharpness of evaluation image that can mask a lack in sharpness in the archival image. Thus, a lack of sharpness in the archival image that is caused, for example, by focusing error during capture of the archival image may not be readily apparent in the evaluation image presented on the display.

Other image elements that may lead to user dissatisfaction with the captured archival image can also be masked in the evaluation image by the down sampling process. For example, the down sampling process can form evaluation images that mask conditions such as red eye, closed eyes, subject motion, handshake and/or other lighting conditions that will be readily apparent when the archival image is presented by display having better resolution or when the archival image is printed. Thus, what is needed is a display device such as a camera with a camera with a display that more effectively presents an image in a way that automatically assists a user in the process of reviewing a digital image.

Various approaches have been used to help a user to determine whether conditions exist in a stored digital image that can lead to dissatisfaction with the stored digital image and that will be masked by the down sampling. For example, commonly-assigned U.S. Pat. No. 5,103,254, entitled “Camera with Subject Highlighting and Motion Detection,” filed by Bell et al. on May 29, 1990 discloses a camera in which a gradient operation is performed on an electronically captured image, in order to produce an outline of subjects within the depth of field. This outline is displayed using a liquid crystal display (LCD) as a mask to highlight the in-focus subject within the camera's viewfinder. Similarly, U.S. Pat. No. 5,496,106, entitled “System and Method of Generating a Contrast Overlay as a Focus Assist for an Display device,” filed by Anderson on Dec. 13, 1994, discloses a system in which an image is split into its red, green, and blue components, a contrast signal is generated, and the contrast signal is combined with one of the color channels to produce a false-color overlay that indicates which area of the captured image is in focus. These color overlays help the photographer by showing the photographer an evaluation image that with a false color overlay indicating portions of the archival image that have been captured in focus. This in turn allows the photographer to determine whether the intended subject of the image was captured in the archival image in focus.

Similarly, commonly assigned U.S. Patent Application Publication No. 2003-0117511A1 entitled “Method and Camera System for Blurring Portions of an Evaluation Image to Show Out of Focus Areas in a Captured Archival Image” filed on Dec. 21, 2001 by Belz et al. describes a camera that detects out of focus areas in an archival image and causes the appearance of the portions of the evaluation image that corresponds to the out of focus areas in the archival image to have a blurred or out of focus appearance when presented on a display.

In some digital cameras, such as the DC-215 camera sold by Eastman Kodak Company, Rochester, N.Y., U.S.A. this problem is addressed by presenting evaluation images at one of two manually selected levels of magnification. In a first mode, the entire evaluation image is formatted and presented on a video display so that the entire evaluation image can be viewed in the display. In a second mode, only a part of the evaluation image can be viewed on the display. Because the entire display or a substantial proportion thereof is used for presenting only a portion of the image, the portion of the evaluation image being viewed has a greater effective magnification than it has when that same portion is viewed in the first mode.

The user can manually adjust what is displayed so that particular portions of the evaluation image can be viewed with increased magnification. However, this requires that a photographer manually selects the magnification mode and manually locates an area of importance in the image in order to make determinations.

It will also be appreciated that as the memory capacity of hand held display devices continues to increase and as the ability of such devices to retrieve images from remote image servers using wired and wireless communication systems becomes more prevalent, such hand-held image display devices are increasingly called upon to present more than one evaluation image at a time. For example a collection of images may be available for viewing using the display device. To help a consumer to sort through these images, it is well known to provide a menu of so-called thumbnail images that each use only a fraction of the image forming capabilities of the display. Where this is done, the extent of the down sampling is increased further masking conditions in an image that may make the image have a less than desirable appearance. Further, in certain circumstances, it can become difficult to discern what is depicted in the thumbnail image.

Thus, what is also needed is a method of forming evaluation images that can be used to facilitate evaluation of archival images when presented in thumbnail form.

### SUMMARY OF THE INVENTION

In one embodiment, the invention is a method for forming an evaluation image for presentation on a display. In accordance with the method an image is obtained having a resolution greater than a resolution of the display and an area of importance automatically determined comprising less than all of the obtained image. Image elements from the area of importance are used to form an area of importance image adapted for presentation on the display; and the area of importance image is presented.

In another embodiment, the invention is a method for using a display having a predetermined image resolution to display an image have greater image resolution than the display. In accordance with the method the image is obtained and an area of importance is determined in the obtained image. An area of importance image is formed containing image information from the area of importance resampled for presentation at the image resolution of the display and the area of importance image is presented on the display.

Another embodiment of the invention is a method for using a display having a predetermined image resolution to display an image have greater image resolution than the display. In accordance with the method the image is obtained and an area of importance is determined in the obtained image. An evaluation image is formed having an appearance that corresponds to the obtained image and is resampled for presentation on the display and the evaluation image is presented. An area of importance image is formed containing imaging information that corresponds to the area of importance resampled for presentation at the display resolution and presenting the area of importance image on the display when an area of importance verification mode is selected.

Another embodiment of the invention is a method for presenting an area of importance in an image. In accordance with the method, an archival image is obtained and an evaluation image is formed corresponding to the appearance of the archival image and resampled for presentation on the display. An area of importance is determined in the archival image. The area of importance comprises less than all of the archival image. An evaluation image is displayed that corresponds to the archival image and an area of importance image is displayed that contains image content that corresponds to the determined area of importance. Wherein the image content of the area of importance as displayed in the area of importance image has a greater effective magnification than the area of importance has as displayed in an evaluation image that corresponds to the archival image.

Another embodiment of the invention is a display device. In this embodiment, the display device has a source of archival images operable to obtain archival images; a display; and a processor adapted to determine an area of importance in an obtained archival image, and to form an area of importance image that contains less than all of the archival image including image information from the area of importance and that is adapted to be presented on the display and to cause the display to present the area of importance image.

Still another embodiment of the invention is a display device. The display device has a source of an archival image; a display; and a signal processor. The signal processor receives the archival image and is capable of forming images for presentation on the display based upon the archival image. A controller is provided and is operable to cause the signal processor to form an evaluation image for presentation on the display and to form an area of importance image for presentation on the display. Wherein the evaluation image depicts what is shown in the archival image and the area of interest image depicts only a portion of the archival image that corresponds to the area of importance.

### BRIEF DESCRIPTION OF THE DRAWINGS

FIG. 1 is an illustration of one embodiment of a display device of the present invention;

FIG. 2 is an illustration of a back view of the display device of FIG. 1;

FIG. 3 is a flow diagram of one embodiment of a method of the present invention;

FIG. 4 illustrates a photographic scene separated into rangefinding regions;

FIG. 5 illustrates an area of importance displayed as part of an evaluation image;

FIG. 6 illustrates a displayed area of importance image;

FIG. 7 illustrates another embodiment of a method of the invention;

FIG. 8 illustrates another embodiment of a method of the invention;

FIGS. 9a, 9b, and 9c each show an archival image;

FIG. 10 shows a conventional thumbnail listing of archival images;

FIG. 11 shows a thumbnail listing of area of importance thumbnail images;

FIG. 12 shows one example embodiment of a combined display of an evaluation image and an area of importance image; and

FIG. 13 shows another example embodiment of a combined display of an evaluation image and an area of importance image.

### DETAILED DESCRIPTION OF THE INVENTION

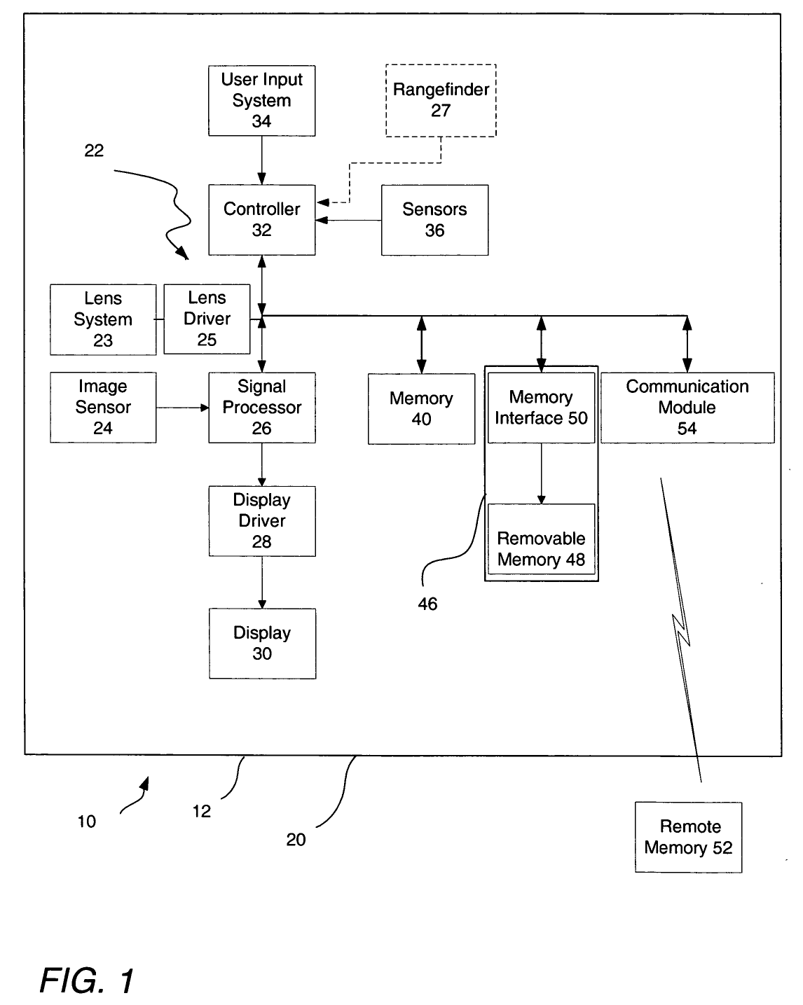

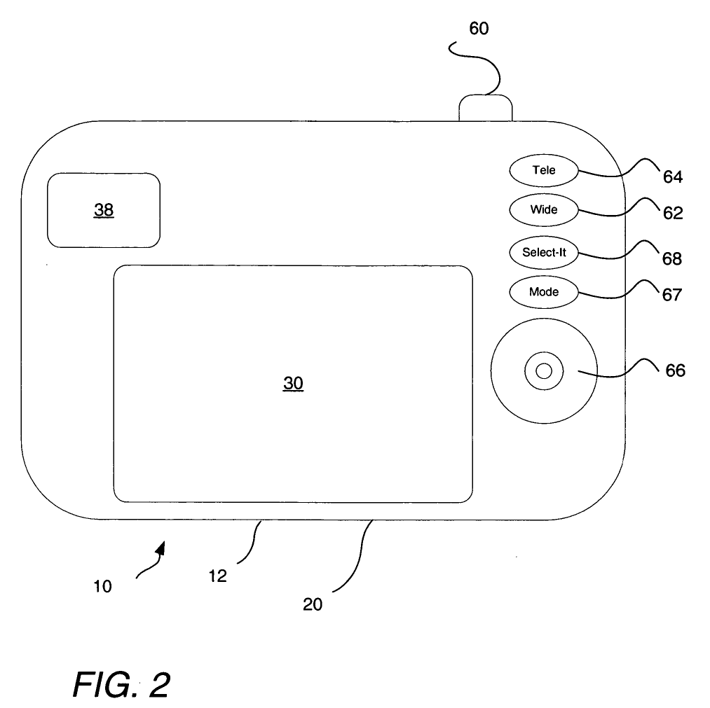

FIG. 1 shows a block diagram of an embodiment of a display device 10. FIG. 2 shows a back, elevation view of the display device 10 of FIG. 1. As is shown in FIGS. 1 and 2, display device 10 takes the form of a digital camera 12 comprising a body 20 containing an image capture system 22 having a lens system 23, an image sensor 24, a signal processor 26, an optional display driver 28 and a display 30. In operation, light from a scene is focused by lens system 23 to form an image on image sensor 24. Lens system 23 can have one or more elements.

Lens system 23 can be of a fixed focus type or can be manually or automatically adjustable. In the embodiment shown in FIG. 1, lens system 23 is automatically adjusted. Lens system 23 can be simple, such as having a single focal length with manual focusing or a fixed focus. In the example embodiment shown in FIG. 1, taking lens unit 22 is a motorized 6×zoom lens unit in which a mobile element or elements (not shown) are driven, relative to a stationary element or elements (not shown) by lens driver 25. Lens driver 25 controls both the lens focal length and the lens focus position of lens system 23 and sets a lens focal length and/or position based upon signals from signal processor 26, an optional automatic range finder system 27, and/or controller 32.

The focal length and/or focus position of lens system 23 can be automatically selected using a variety of known strategies. For example, in one embodiment, image sensor 24 is used to provide multi-spot autofocus using what is called the “through focus” or “whole way scanning” approach. In such an approach the scene is divided into a grid of regions or spots, and the optimum focus distance is determined for each image region. The optimum focus distance for each region is determined by moving lens system 23 through a range of focus distance positions, from the near focus distance to the infinity position, while capturing images. Depending on the design of digital camera 12, between four and thirty-two images may need to be captured at different focus distances. Typically, capturing images at eight different distances provides suitable accuracy.

The captured image data is then analyzed to determine the optimum focus distance for each image region. This analysis begins by band-pass filtering the sensor signal using one or more filters, as described in commonly assigned U.S. Pat. No. 5,874,994 “Filter Employing Arithmetic Operations for an Electronic Synchronized Digital Camera” filed by Xie et al., on Dec. 11, 1995, the disclosure of which is herein incorporated by reference. The absolute value of the bandpass filter output for each image region is then peak detected, in order to determine a focus value for that image region, at that focus distance. After the focus values for each image region are determined for each captured focus distance position, the optimum focus distances for each image region can be determined by selecting the captured focus distance that provides the maximum focus value, or by estimating an intermediate distance value, between the two measured captured focus distances which provided the two largest focus values, using various interpolation techniques.

The lens focus distance to be used to capture a digital image can be determined using known algorithms. In a preferred embodiment, the image regions corresponding to a target object (e.g. a person being photographed) are determined. The focus position is then set to provide the best focus for these image regions. For example, an image of a scene can be divided into a plurality of sub-divisions. A focus evaluation value representative of the high frequency component contained in each subdivision of the image can be determined and the focus evaluation values can be used to determine object distances as described in commonly assigned U.S. Pat. No. 5,877,809 entitled “Method Of Automatic Object Detection In An Image”, filed by Omata et al. on Oct. 15, 1996, the disclosure of which is herein incorporated by reference. If the target object is moving, object tracking may be performed, as described in commonly assigned U.S. Pat. No. 6,067,114 entitled “Detecting Compositional Change in Image” filed by Omata et al. on Oct. 26, 1996, the disclosure of which is herein incorporated by reference. In an alternative embodiment, the focus values determined by “whole way scanning” are used to set a rough focus position, which is refined using a fine focus mode, as described in commonly assigned U.S. Pat. No. 5,715,483, entitled “Automatic Focusing Apparatus and Method”, filed by Omata et al. on Oct. 11, 1998, the disclosure of which is herein incorporated by reference.

In one embodiment, bandpass filtering and other calculations used to provide auto-focus information for digital camera 12 are performed by digital signal processor 26. In this embodiment, digital camera 12 uses a specially adapted image sensor 24, as is shown in commonly assigned U.S. Pat. No. 5,668,597 entitled “An Electronic Camera With Rapid Automatic Focus Of An Image Upon A Progressive Scan Image Sensor”, filed by Parulski et al. on Dec. 30, 1994, the disclosure of which is herein incorporated by reference, to automatically set the lens focus position. As described in the '597 patent, only some of the lines of sensor photoelements (e.g. only ¼ of the lines) are used to determine the focus. The other lines are eliminated during the sensor readout process. This reduces the sensor readout time, thus shortening the time required to focus lens system 23.

In an alternative embodiment, digital camera 12 uses a separate optical or other type (e.g. ultrasonic) of rangefinder 27 to identify the subject of the image and to select a focus position for lens system 23 that is appropriate for the distance to the subject. Rangefinder 27 can operate lens driver 25, directly or as shown in FIG. 1, can provide signals to signal processor 26 or controller 32 from which signal processor 26 or controller 32 can generate signals that are to be used for image capture. A wide variety of suitable multiple sensor rangefinders 27 known to those of skill in the art are suitable for use. For example, U.S. Pat. No. 5,440,369 entitled “Compact Camera With Automatic Focal Length Dependent Exposure Adjustments” filed by Tabata et al. on Nov. 30, 1993, the disclosure of which is herein incorporated by reference, discloses one such rangefinder 27. The focus determination provided by rangefinder 27 can be of the single-spot or multi-spot type. Preferably, the focus determination uses multiple spots. In multi-spot focus determination, the scene is divided into a grid of areas or spots, and the optimum focus distance is determined for each spot. One of the spots is identified as the subject of the image and the focus distance for that spot is used to set the focus of lens system 23.

A feedback loop is established between lens driver 25 and camera controller 32 so that camera controller 32 can accurately set the focus position of lens system 23.

Lens system 23 is also optionally adjustable to provide a variable zoom. In the embodiment shown lens driver 25 automatically adjusts the position of one or more mobile elements (not shown) relative to one or more stationary elements (not shown) of lens system 23 based upon signals from signal processor 26, an automatic range finder system 27, and/or controller 32 to provide a zoom magnification. Lens system 23 can be of a fixed magnification, manually adjustable and/or can employ other known arrangements for providing an adjustable zoom.

Light from the scene that is focused by lens system 23 onto image sensor 24 is converted into image signals representing an image of the scene. Image sensor 24 can comprise a charge couple device (CCD), a complimentary metal oxide sensor (CMOS), or any other electronic image sensor known to those of ordinary skill in the art. The image signals can be in digital or analog form.

Signal processor 26 receives image signals from image sensor 24 and transforms the image signals into an image in the form of digital data. The digital image can comprise one or more still images, multiple still images and/or a stream of apparently moving images such as a video segment. Where the digital image data comprises a stream of apparently moving images, the digital image data can comprise image data stored in an interleaved or interlaced image form, a sequence of still images, and/or other forms known to those of skill in the art of digital video.

Signal processor 26 can apply various image processing algorithms to the image signals when forming a digital image. These can include but are not limited to color and exposure balancing, interpolation and compression. Where the image signals are in the form of analog signals, signal processor 26 also converts these analog signals into a digital form.

Controller 32 controls the operation the display device 10 during imaging operations, including but not limited to image capture system 22, display 30 and memory such as memory 40. Controller 32 causes image sensor 24, signal processor 26, display 30 and memory 40 to capture and store archival images in response to signals received from a user input system 34, data from signal processor 26 and data received from optional sensors 36. Controller 32 can comprise a microprocessor such as a programmable general purpose microprocessor, a dedicated micro-processor or micro-controller, a combination of discrete components or any other system that can be used to control operation of display device 10.

Controller 32 cooperates with a user input system 34 to allow display device 10 to interact with a user. User input system 34 can comprise any form of transducer or other device capable of receiving an input from a user and converting this input into a form that can be used by controller 32 in operating display device 10. For example, user input system 34 can comprise a touch screen input, a touch pad input, a 4-way switch, a 6-way switch, an 8-way switch, a stylus system, a trackball system, a joystick system, a voice recognition system, a gesture recognition system or other such systems. In the digital camera 12 embodiment of display device 10 shown in FIGS. 1 and 2 user input system 34 includes a shutter trigger button 60 that sends a trigger signal to controller 32 indicating a desire to capture an image.

In the embodiment shown in FIGS. 1 and 2, user input system 34 also includes a wide-angle zoom button 62, and a tele-zoom button 64 that cooperate with controller 32 to control the zoom settings of lens system 23 causing lens system 23 to zoom out when wide angle zoom button 62 is depressed and to zoom in when tele-zoom button 64 is depressed. Wide-angle zoom lens button 62 and telephoto zoom button 64 can also be used to provide signals that cause signal processor 26 to process image signal so that the digital image formed thereby appears to have been captured at a different zoom setting than that actually provided by the optical lens system. This can be done by using a subset of the image signals from image sensor 24 and interpolating the subset of the image signals to form the digital image. User input system 34 can also include other buttons including joystick 66 shown in FIG. 2, the mode selector button 67 and select-it button 68 shown in FIG. 2, the function of which will be described in greater detail below.

Sensors 36 are optional and can include light sensors and other sensors known in the art that can be used to detect conditions in the environment surrounding display device 10 and to convert this information into a form that can be used by controller 32 in governing operation of display device 10. Sensors 36 can also include biometric sensors adapted to detect characteristics of a user for security and affective imaging purposes.

Controller 32 causes an image signal and corresponding digital image to be formed when a trigger condition is detected. Typically, the trigger condition occurs when a user depresses shutter trigger button 60, however, controller 32 can determine that a trigger condition exists at a particular time, or at a particular time after shutter trigger button 60 is depressed. Alternatively, controller 32 can determine that a trigger condition exists when optional sensors 36 detect certain environmental conditions.

Controller 32 can also be used to generate metadata in association with each image. Metadata is data that is related to a digital image or a portion of a digital image but that is not necessarily observable in the image data itself. In this regard, controller 32 can receive signals from signal processor 26, camera user input system 34 and other sensors 36 and, optionally, generates metadata based upon such signals. The metadata can include but is not limited to information such as the time, date and location that the archival image was captured, the type of image sensor 24, mode setting information, integration time information, taking lens unit setting information that characterizes the process used to capture the archival image and processes, methods and algorithms used by display device 10 to form the archival image. The metadata can also include but is not limited to any other information determined by controller 32 or stored in any memory in display device 10 such as information that identifies display device 10, and/or instructions for rendering or otherwise processing the digital image with which the metadata is associated. The metadata can also comprise an instruction to incorporate a particular message into digital image when presented. Such a message can be a text message to be rendered when the digital image is presented or rendered. The metadata can also include audio signals. The metadata can further include digital image data. The metadata can also include any other information entered into display device 10.

The digital images and optional metadata, can be stored in a compressed form. For example where the digital image comprises a sequence of still images, the still images can be stored in a compressed form such as by using the JPEG (Joint Photographic Experts Group) ISO 10918-1 (ITU-T.81) standard. This JPEG compressed image data is stored using the so-called “Exif” image format defined in the Exchangeable Image File Format version 2.2 published by the Japan Electronics and Information Technology Industries Association JEITA CP-3451. Similarly, other compression systems such as the MPEG-4 (Motion Pictures Export Group) or Apple QuickTime™ standard can be used to store digital image data in a video form. Other image compression and storage forms can be used.

The digital images and metadata can be stored in a memory such as memory 40. Memory 40 can include conventional memory devices including solid state, magnetic, optical or other data storage devices. Memory 40 can be fixed within display device 10 or it can be removable. In the embodiment of FIG. 1, display device 10 is shown having a memory card slot 46 that holds a removable memory 48 such as a removable memory card and has a removable memory interface 50 for communicating with removable memory 48. The digital images and metadata can also be stored in a remote memory system 52 that is external to display device 10 such as a personal computer, computer network or other imaging system.

In the embodiment shown in FIGS. 1 and 2, display device 10 has a communication module 54 for communicating with the remote memory system. The communication module 54 can be for example, an optical, radio frequency or other transducer that converts image and other data into a form that can be conveyed to the remote display device by way of an optical signal, radio frequency signal or other form of signal. Communication module 54 can also be used to receive a digital image and other information from a host computer or network (not shown). Controller 32 can also receive information and instructions from signals received by communication module 54 including but not limited to, signals from a remote control device (not shown) such as a remote trigger button (not shown) and can operate display device 10 in accordance with such signals.

Signal processor 26 and/or controller 32 also use image signals or the digital images to form evaluation images which have an appearance that corresponds to archival images stored in display device 10 and are adapted for presentation on display 30. This allows users of display device 10 to use a display such as display 30 to view images that correspond to archival images that are available in display device 10. Such images can include, for example images that have been captured by image capture system 22, and/or that were otherwise obtained such as by way of communication module 54 and stored in a memory such as memory 40 or removable memory 48.

Display 30 can comprise, for example, a color liquid crystal display (LCD), organic light emitting display (OLED) also known as an organic electro-luminescent display (OELD) or other type of video display. Display 30 can be external as is shown in FIG. 2, or it can be internal for example used in a viewfinder system 38. Alternatively, display device 10 can have more than one display 30 with, for example, one being external and one internal.

Signal processor 26 and/or controller 32 can also cooperate to generate other images such as text, graphics, icons and other information for presentation on display 30 that can allow interactive communication between controller 32 and a user of display device 10, with display 30 providing information to the user of display device 10 and the user of display device 10 using user input system 34 to interactively provide information to display device 10. Display device 10 can also have other displays such as a segmented LCD or LED display (not shown) which can also permit signal processor 26 and/or controller 32 to provide information to user 10. This capability is used for a variety of purposes such as establishing modes of operation, entering control settings, user preferences, and providing warnings and instructions to a user of display device 10. Other systems such as known systems and actuators for generating audio signals, vibrations, haptic feedback and other forms of signals can also be incorporated into display device 10 for use in providing information, feedback and warnings to the user of display device 10.

Typically, display 30 has less imaging resolution than image sensor 24. Accordingly, signal processor 26 reduces the resolution of image signal or digital image when forming evaluation images adapted for presentation on display 30. Down sampling and other conventional techniques for reducing the overall imaging resolution can be used. For example, resampling techniques such as are described in commonly assigned U.S. Pat. No. 5,164,831 “Electronic Still Camera Providing Multi-Format Storage Of Full And Reduced Resolution Images” filed by Kuchta et al., on Mar. 15, 1990, can be used. The evaluation images can optionally be stored in a memory such as memory 40. The evaluation images can be adapted to be provided to an optional display driver 28 that can be used to drive display 30. Alternatively, the evaluation images can be converted into signals that can be transmitted by signal processor 26 in a form that directly causes display 30 to present the evaluation images. Where this is done, display driver 28 can be omitted.

Display device 10 can obtain archival images for processing in a variety of ways. For example, display device 10 can obtain digital images using image capture system 22 as described above. Imaging operations that can be used to obtain digital images using image capture system 22 include a capture process and can optionally also include a composition process and a verification process.

During the optional composition process, controller 32 optionally provides an electronic viewfinder effect on display 30. In this regard, controller 32 causes signal processor 26 to cooperate with image sensor 24 to capture preview digital images during composition and to present a corresponding evaluation images on display 30.

In the embodiment shown in FIGS. 1 and 2, controller 32 enters the image composition process when shutter trigger button 60 is moved to a half depression position. However, other methods for determining when to enter a composition process can be used. Any component of user input system 34 can be used for this purpose; for example, the “mode” button 67 or the “select-it” button 68 shown in FIG. 2 can be depressed by a user of display device 10, and can be interpreted by controller 32 as an instruction to enter the composition process. The evaluation images presented during composition can help a user to compose the scene for the capture of an archival image.

The capture process is executed in response to controller 32 determining that a trigger condition exists. In the embodiment of FIGS. 1 and 2, a trigger signal is generated when shutter trigger button 60 is moved to a full depression condition and controller 32 determines that a trigger condition exists when controller 32 detects the trigger signal. During the capture process, controller 32 sends a capture signal causing signal processor 26 to obtain image signals from image sensor 24 and to process the image signals to form digital image data comprising an archival image.

During the verification process, an evaluation image corresponding to the digital image is optionally formed for presentation on display 30 by signal processor 26 based upon the image signal. In one alternative embodiment, signal processor 26 converts each image signal into an archival image and then derives the corresponding evaluation image from the archival images. The corresponding evaluation image is supplied to display 30 and is presented for a period of time. This permits a user to verify that the archival image has a preferred appearance.

Digital images can also be obtained by display device 10 in ways other than image capture. For example digital images can by conveyed to display device 10 when such images are recorded on a removable memory 48 that is operatively associated with memory interface 50. Alternatively, digital images can be received by way of communication module 54. Where communication module 54 is adapted to communicate by way of a cellular telephone network, communication module 54 can be associated with a cellular telephone number or other identifying number that for example another user of the cellular telephone network such as the user of a telephone equipped with a digital camera can use to establish a communication link between display device 10 and a remote memory 52 such as an image sensor (not shown) which can transmit images that are received by communication module 54. Accordingly, there are a variety of ways in which display device 10 can receive images and therefore it is not essential that display device 10 have an image capture system so long as other means such as those described above are available for importing images into display device 10.

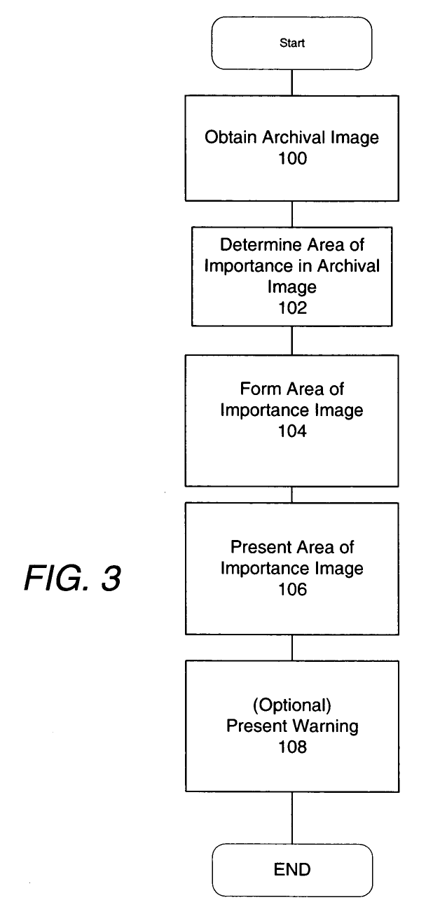

FIG. 3 shows one embodiment of a method for presenting an area of importance image. As is shown in FIG. 3, an archival digital image is obtained and stored. This can be done by capture, or by importing the archival images as discussed above or using other conventional archival image capture or downloading techniques (step 100).

An area of importance determination is then made that identifies an area within the archival image that contains image content that is determined to be important (step 102).

Image content that corresponds to image content from the area importance in the archival image is then used to form an area of importance image (step 104). This image content can be down sampled and/or otherwise processed in a manner that allows the area of importance image to be presented on display 30 (step 106). Because less than all of the stored image is presented on display 30, the extent of the down sampling used form the area of importance image is lower than the extent of the down sampling that would be required to present an evaluation image that includes all of the image content from the archival image on display 30. Therefore, the area of importance image shows image content from the area of importance as having an appearance that is apparently magnified as compared to appearance of the same image content in the evaluation image.

To avoid confusion, a warning such as video, audio, or other signals can optionally be presented along with the area of importance evaluation image to indicate to user of display device 10 that the image being presented does not include all of the captured in stored image content of the archival image (step 108).

Determining the Area of Importance

There are a variety of ways in which the area of importance can be automatically determined for use in generating an area of importance image. In one embodiment, the area of importance determination is based upon auto-focusing information. For example, in the embodiment of FIGS. 1 and 2, signal processor 26 and/or camera controller 32 can use information obtained during an automatic focusing process to determine which area of an image is an area of importance. As is discussed above, multi-spot range finding techniques used for focus setting determine focus distances for a number of areas or spots within a photographic scene. These techniques further identify a subject area or spot containing the subject of the scene. A focus distance for that area is used to the set the focus distance of lens system 23 during the process of capturing and storing the image. Where this is done, signal processor 26, and controller 32 define the area of importance within the stored image as an area that corresponds to the subject area. As will be discussed in greater detail below, a variety of other methods can be used to determine the area of importance.

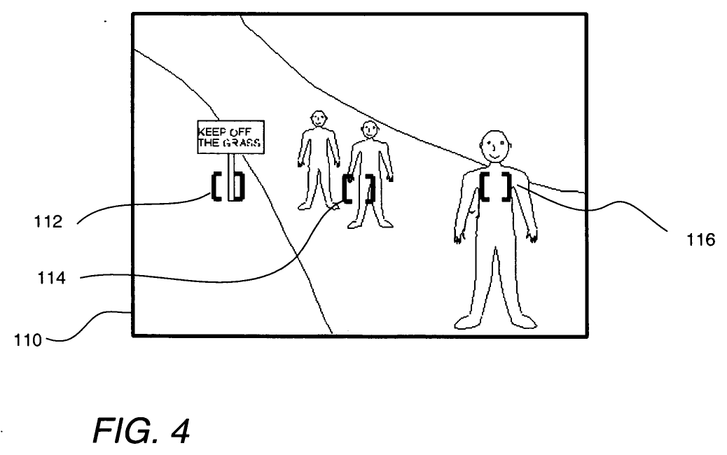

FIG. 4 illustrates in detail, how autofocus information can be used to determine an area of importance. As is shown in FIG. 4, during a range finding operation a photographic scene 110 is divided into a series of focus regions, 112, 114 and 116. Region 116 is selected as the subject of the image using conventional auto-focusing regions and/or manual input. Lens system 23 is then adjusted based upon the distance from rangefinder 27 to region 116.

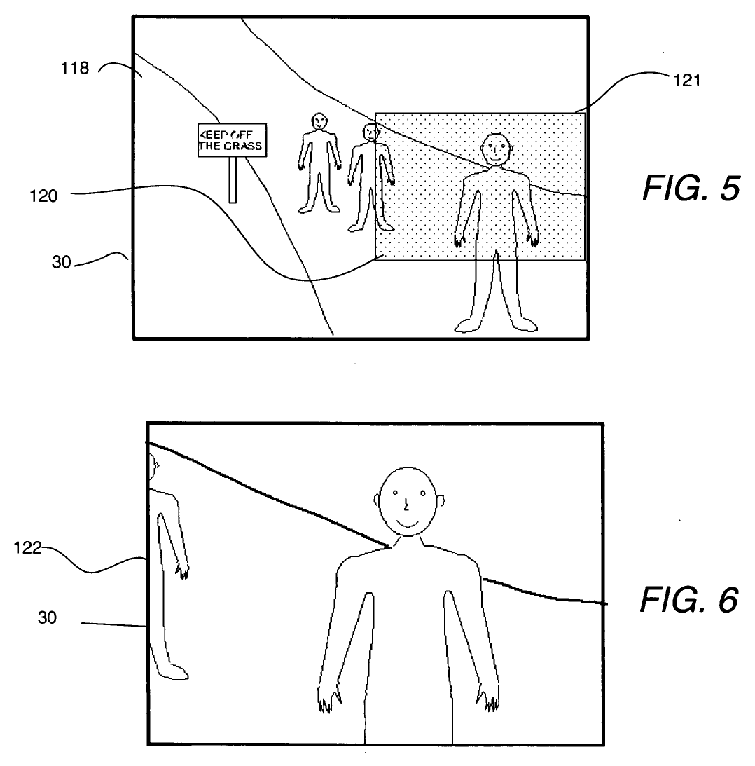

As is shown in FIG. 5, an archival image of scene 110 is captured and an evaluation image 118 is formed for presentation on display 30. An area of importance 120 corresponding to region 116 is identified. As can be observed in the shape, size, and other characteristics of area of importance 120 can be defined in any of a number of ways. For example, area of importance 120 can comprise a predefined or user defined area of importance template 121 that is located within the archival image based upon the identified region. In another example, the area of importance 120 can be adaptively defined based upon characteristics of the scene 110 or by analysis of only the portion of the scene in the subject area 116 such as an illumination pattern, focus pattern and other such image characteristics.

As is illustrated in FIG. 5, area of importance 120 comprises only a fraction of the total evaluation image 118 and therefore when evaluation image 118 is presented using display 30, area of importance 120 comprises a corresponding fraction of the total evaluation image 118 and therefore has an initial magnification level that is relatively small.

FIG. 6 shows an area of importance image 122 formed by obtaining image information from an area of the archival image that corresponds to the area of importance 120. In this illustration, the obtained image information is contained within the area of importance template 121. The image information obtained from within area of importance template 121 is resampled form the area of importance image 122 for presentation on a larger fraction of the display 30 than is occupied by the area of importance 120 when the entire evaluation image 118 is presented on display 30. This increases the effective magnification of area of importance 120. This also provides a user of display device 10 with a better opportunity to detect problems in area of importance 120. Area of importance image 122 can comprise only obtained image information from the area of importance and can also comprise other image information from image 118. Here too, a predefined template (not shown) can be used to determine what image information is contained within the area of importance image 122 or the image information contained within the area of importance image can be adaptively defined based upon analysis of the scene, the archival image, or the area of importance.

Alternatively, it will be recalled that in other embodiments, through focusing or whole way scanning techniques can be used to determine a focus distance for taking lens system 23. As is discussed in above, during the process of “through focusing” or “whole way scanning”, an area of the scene is identified as the subject of the image and taking lens system 23 is set to a focus distance that is appropriate for capturing this area of the scene in focus. The area of the scene selected for focus can be correlated to the captured archival image to identify the area of importance in the archival image in a manner similar to that described with reference to FIGS. 4, 5, and 6.

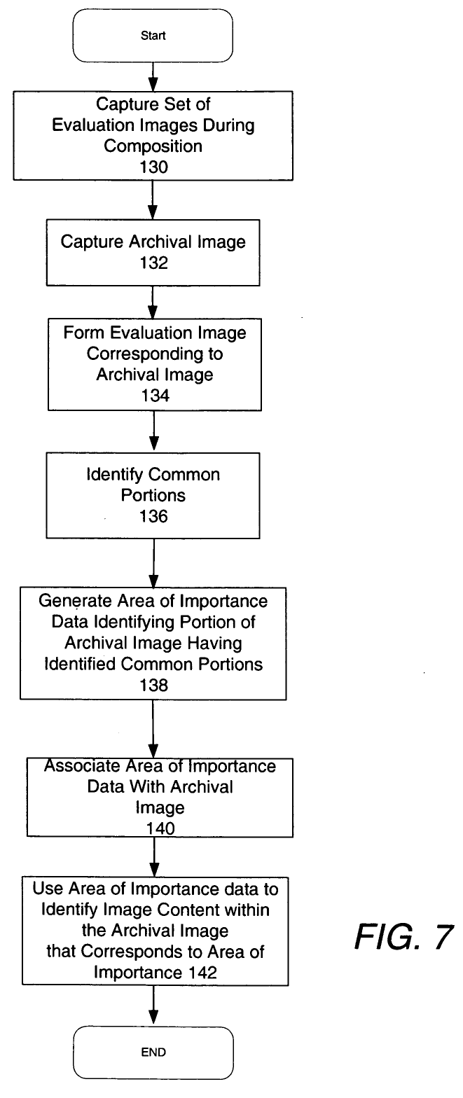

FIG. 7 shows another method for determining an area of importance in an archival image. In this embodiment, methods described in commonly assigned U.S. patent application Ser. No. 10/324,489 entitled IMAGING METHOD AND SYSTEM FOR DETERMINING AN AREA OF THE IMPORTANCE IN AN ARCHIVAL IMAGE filed by Fredlund on Dec. 20, 2002, are used to determine an area of importance based upon changes made in the field of view of the image capture system during image composition.

In the embodiment of FIG. 7, display device 10 comprises for example, a digital camera 12 that includes an image capture system 22. Digital camera 12 obtains an archival image by using an image composition process as described above. During the image composition process, a set of evaluation images are captured (130). An archival image is captured and stored (step 132). An evaluation image corresponding to the archival image is formed (step 134). The corresponding evaluation image is compared to the set of evaluation images to identify common portions of the evaluation images (step 136). Area of importance data is generated indicating the portions of the stored archival image that correspond to the common portions of the evaluation images (step 138). The area of importance data is then associated with the archival image (step 140). The area of importance data associated with the archival image is then used to identify portions of the archival image that are in the area of importance (step 142).

In this way, the area of importance information can be determined during capture without use of auto-focusing algorithms. Other techniques for determining an area of importance in a digital image using one or more evaluation images captured during image composition can also be used such as other methods described in the above identified Fredlund application.

In another alternate embodiment image analysis techniques are used to identify an area importance in a stored archival image. For example, large oval shaped objects having color that approximates known flesh tones can be assumed to be important. The degree of presumed importance can be increased where, for example, the large oval face shaped objects are positioned near the center of an image. See for example, commonly assigned U.S. Pat. No. 6,282,317, entitled “Method For Automatic Determination of Main Subjects in Photographic Images”, filed by Luo et al. on Dec. 31, 1998.

Image analysis of the archival image can further detect the presence of preferred subjects in the archival image. For example, many consumer cameras for typically owned by a single user or family and therefore, images that contains family members and portions of images that contain family members can be presumed to be of importance. In this regard, display device 10 can receive template images that identify for example family members, or other and objects photographic subjects that can be of interest. In this embodiment, the stored digital images are analyzed to locate the faces, objects, or image patterns of interest within the stored digital images and, portions of the digital image containing the faces, objects, or image patterns of interest can be identified as an area importance. Thus, where analysis of its archival images indicates that certain portions of the archival images contain an image of a family member, an area importance can be defined in an area that surrounds the image of the family member.

In another embodiment, frequency analysis of the digital data that forms the stored digital image can be used to identify elements of the stored digital image that are considered to be of greater importance. Such algorithms can be used to make assumptions about what is important in an image based upon analysis of the visual elements of the captured image. See for example commonly assigned U.S. patent application Ser. No. 09/176,805 entitled “Determining Portions of a Digital Image Which are In Focus”, filed by Erkkilea et al. on Oct. 22, 1998 and incorporated herein by reference. In the '805 application, a frequency information in digital data comprising a stored digital image is analyzed to identify at least one area of the stored digital image that is believed to be in focus and a map circumscribing this area is overlaid on the displayed evaluation image. The same techniques described in the '805 application can also be used to identify an area of importance with the area of importance being based upon the area determined to be in focus.

In some situations, it can occur that an image stored in display device 10 will be associated with some form of metadata that indicates which portions of the stored digital image comprise an area of importance. For example, stored digital images may contain metadata calling for artificially induced artifacts to be included in the archival image such as borders, text, and other material that at least partially block the image. Areas of the archival image that are blocked by such artifacts can be considered to be outside the area of importance. In another example, the stored digital images can contain metadata with editing instructions such as aspect ratio selections or recommendations that can be used to define portions of the stored digital image that comprise the area of importance. Where such metadata is found in association with the image the metadata can be used to define portions of the stored digital image that comprise the area of importance. A single display device 10 can use one or more than one of the above described methods for determining an area of importance in a stored digital image.

In a still further embodiment, signal processor 26 and controller 32 are adapted to analyze illumination patterns in the an archival image and determine, based upon analysis of the illumination patterns, where the area importance is in the archival image. For example, is known to use cameras to provide many as 30,000 potential scene configurations in a memory and comparing illumination patterns from a scene to the potential scene configurations in order to make exposure and focus determinations. The same techniques that are used to make focus determinations can also be used to identify an area of importance.

Presentation of Area of Importance Image

There are various ways in which the evaluation image can be presented to a user of the display device 10. In one embodiment, an display device 10 can be adapted to automatically present area of importance images whenever an image is to be evaluated. This mode of operation can be preset. This mode can also be selectably set using for example user input system 34.

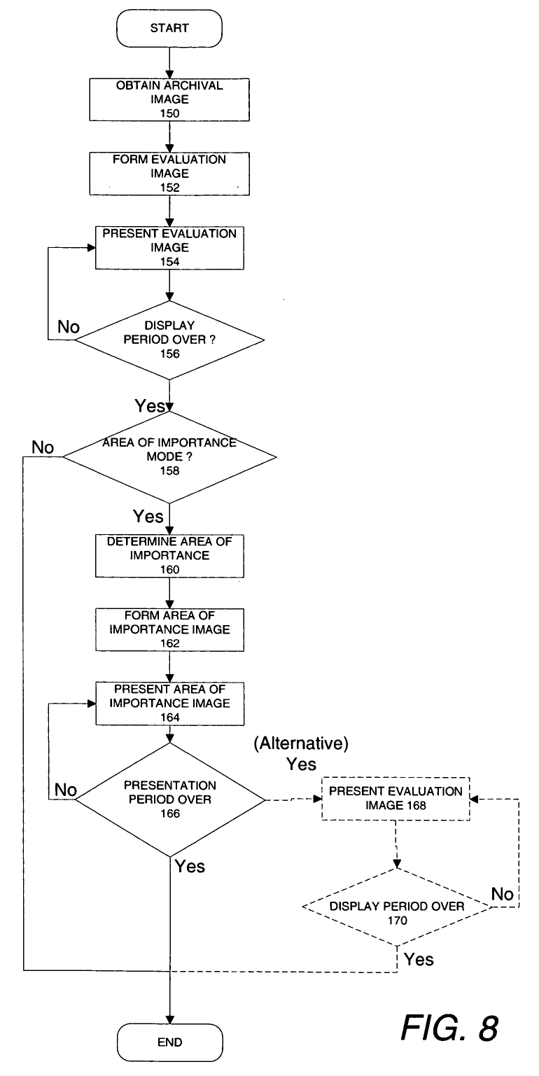

In other embodiments, a combination of an evaluation image and an area of importance image can be provided to facilitate the image review process. For example, FIG. 8 shows a embodiment for displaying the evaluation image and area of importance image during one verification process. In this embodiment, display device 10 obtains an archival image for example by using image capture system 22 to capture the image and store the archival image in a memory (step 150). An evaluation image is then formed in the manner described above having an appearance that generally corresponds to the composition and content of the stored archival image but is resampled and/or otherwise adapted for presentation on exterior display 30 (step 152).

The evaluation image is presented (step 154) for a first display period that typically begins immediately after the evaluation image is prepared and extends for a period of time that is that is long enough to permit user to observe and examine the evaluation image (step 156).

An optional mode detection determining step (step 158) is also provided. In this step, controller 32 determines whether to automatically present an area of importance image in addition to the evaluation image. In one embodiment, this determination is made manually, with a user entering a mode selection that way of user input system 34. This mode selection can comprise selecting that an area of importance presentation image will automatically be presented after each evaluation image. Alternatively, the mode selection can be manually executed by monitoring user interface system 34 during presentation of the evaluation image to detect whether the “select-it” button 66 or some other button or transducer has been activated to indicate a desire to see an area of importance image.

In another embodiment, the mode selection determination (step 158) is performed automatically. For example, camera controller 32 and/or signal processor 28 can examine camera conditions at the time that an archival image is captured and/or examine the archival image and determine that there is a possibility based upon such examinations that the area of importance in the archival image might not have an appearance that is acceptable. When such conditions are detected controller 32 automatically selects area of importance image display mode.

When an area of importance image display mode has been selected, the area of importance is determined for the archival image using any of the methods identified above (step 160). An area of importance image is then formed as described above (step 162) and is resampled for presentation. This area of importance image is presented (step 164) for a period of time (step 166). After the area of importance image has been presented, the presentation can end.

However, in one alternate embodiment shown in dashed lines in FIG. 8, after the area of importance image has been presented for a period of time on display 30, the evaluation image can again be displayed (step 168) in order to provide context for the area of importance image. The display of the evaluation image is then discontinued after a display period (step 170).

As described above, the image information used to form the area of importance image is resampled for presentation on an area that occupies a larger proportion of the imaging area of display 30 than the area of importance occupies when the evaluation image is displayed.

Accordingly, the area of importance image shows the area of importance with greater apparent magnification than the evaluation image shows the same area. The resampling is done so that the area of focus image shows the area of focus in greater detail than the area of importance will appear in the archival image. By providing such an area of importance image automatically to a user the user can more efficiently evaluate important areas of the captured archival image and to make meaningful decisions about using the image or capturing another.

In one embodiment the area of importance image can be resampled so that it is sized to occupy an entire display area of display 30. An example of this is illustrated in FIG. 6.

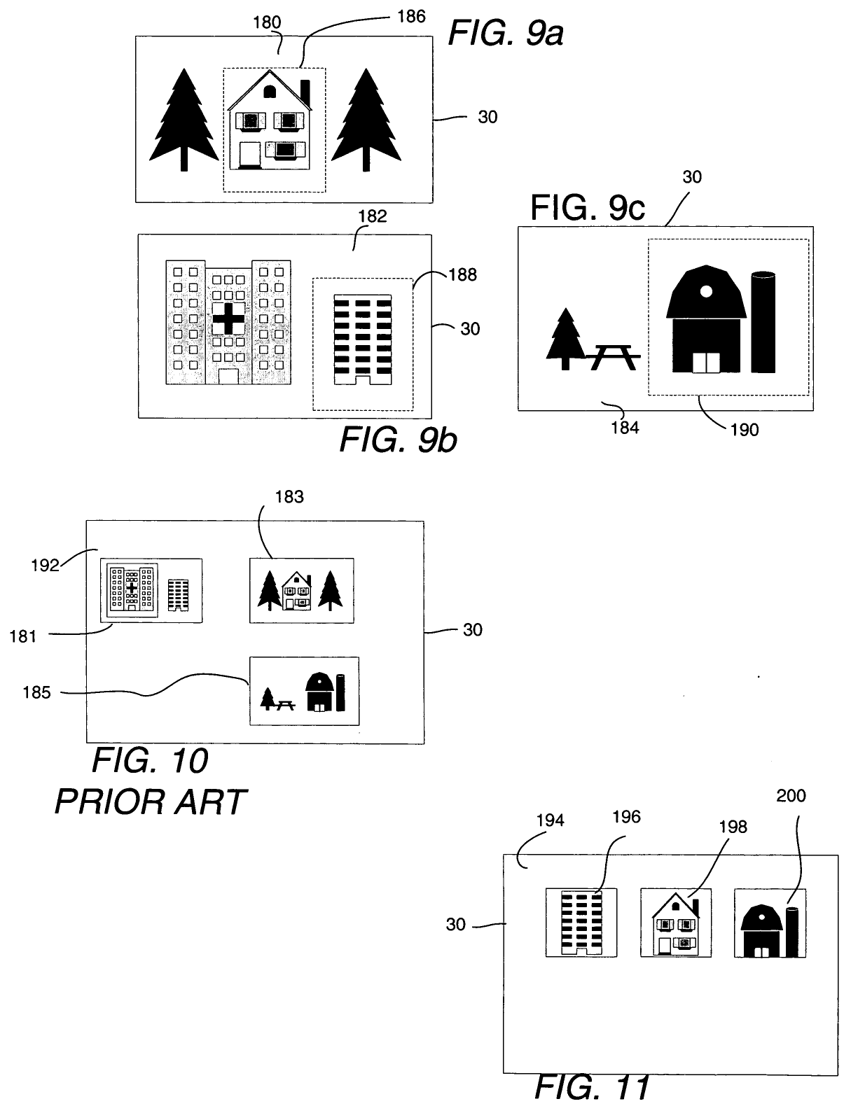

In other embodiments, the area of importance image is resampled so that it too uses only a portion of the available display area of display 30. For example, the area of importance image can be used to provide a thumbnail type image. FIGS. 9a, 9b, and 9c each show an archival image, images 180, 182, and 184 each having an area of importance 186, 188, and 190 respectively. FIG. 10 shows a thumbnail listing 192 of evaluation images 181, 183, and 185 that correspond respectively to archival images 180, 182, and 184. This is known in the art.

FIG. 11 shows a thumbnail listing 194 of area of importance images 196, 198, and 200 that are obtained from areas of importance 186, 188, and 190 respectively. It will be appreciated that the image content of area of importance thumbnail evaluation images 196, 198, and 200 are more easily evaluated.

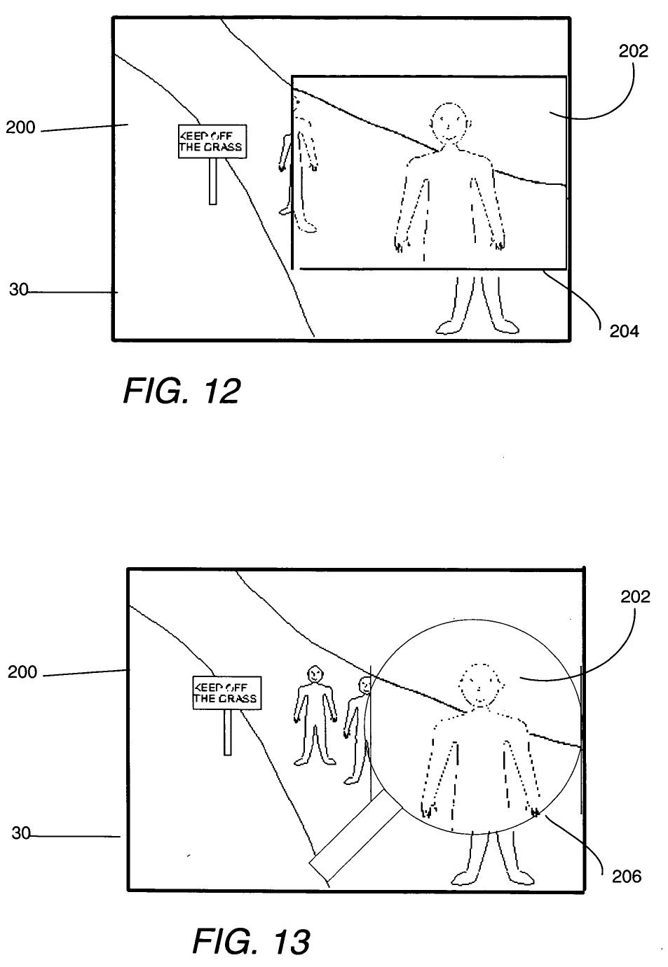

FIG. 12 shows an example embodiment of a combined display of an evaluation image 200 and an area of importance image 202. In FIG. 12, the area of importance image 202 is resampled so that it has greater apparent magnification than evaluation image 200, however it is also sampled to a size that allows a user to view an evaluation image 202 and the area of importance 204 image concurrently so that the user has the opportunity to understand that the area of importance image in context with the evaluation image. As is shown in FIG. 12, during the time that the area of importance image 200 is presented, the area of importance image 202 is presented as in insert in evaluation image 200. A border 204 separates the images.

FIG. 13, shows another example embodiment of a combined display of an evaluation image and an area of importance image. In this embodiment, border 206 is provided that has the appearance of a magnifying glass or some other useful iconic symbol to indicate that the region being observed is being viewed in an enlarged form.

The invention has been described in detail with particular reference to certain preferred embodiments thereof, but it will be understood that variations and modifications can be effected within the spirit and scope of the invention.

### Parts List

10 display device
12 digital camera
20 body
22 image capture system
23 lens system
24 image sensor
25 lens driver
26 signal processor
27 rangefinder
28 display driver
30 display
32 controller
34 user input system
36 sensors
40 memory
46 memory card slot
48 removable memory
50 memory interface
52 remote memory
54 communication module
38 viewfinder
60 capture button
62 wide button
64 tele button
66 joystick
67 mode button
68 select-it button
100 obtain archival image step
102 determine area of importance step
104 form area of importance image step
106 present area of importance image
108 provide warning
110 scene
112 focus region
114 focus region
116 focus region
118 evaluation image
120 area of importance
121 area of importance template
122 area of importance image
130 capture set of preview evaluation images step
132 capture archival image step
134 form evaluation image step
136 identify common portions step
138 generate area importance date identifying portion of archival image having identified common portions step
140 associate area importance data with archival image step
142 use area importance data to identify image content within archival image that corresponds to area of importance step
150 obtained archival image step
152 form evaluation image step
154 present evaluation image step
156 display period over determining step
158 area of importance mode determining step
160 area of importance determining step
162 form area of importance image step
164 present area importance image
166 presentation period over determining step
168 display evaluation image step
170 display period over determining step
180 archival image
181 evaluation image
182 archival image
183 evaluation image
184 archival image
185 evaluation image
186 area of importance
188 area of importance
190 area of importance
192 thumbnail listing of archival images
194 for thumbnail listing area importance images
196 area of importance image
198 area of importance image
200 evaluation image
202 area of importance image
204 border
206 border

1. A method for forming an evaluation image for presentation on a display, the method comprising the steps of:
obtaining an image having a resolution greater than a resolution of the display;
automatically determining an area of importance comprising less than all of the obtained image;
using image elements from the area of importance to form an area of importance image adapted for presentation on the display; and
presenting the area of importance image.

2. The method of claim 1, wherein the area of importance image is formed so that the area of importance image occupies a larger proportion of the resolution of the display than image information in the area of importance image would occupy where an evaluation image containing substantially all of the image information from the archival image is presented on the display.

3. The method of claim 1, wherein the step of obtaining the image comprises receiving the image from a remote source.

4. The method of claim 1, wherein the step of determining an area of importance comprises automatically detecting an area of focus in the image obtained and defining an area of importance based upon the determined area of focus.

5. The method of claim 1, wherein the step of determining an area of importance comprises automatically detecting an area of importance based upon changes in the field of view detected during composition of the image.

6. The method of claim 1, wherein the step of obtaining the image comprises the steps of performing a rangefinding operation wherein a subject area of the image is determined and capturing an image based upon the distance to the area of importance, further wherein the step of determining an area of importance comprises defining the area of importance based upon the determined subject area of the image.

7. The method of claim 1, wherein the step of determining an area of importance in the obtained image comprises determining the area of importance based upon rangefinding information measured during capture of the image obtained.

8. A method for using a display having a predetermined image resolution to display an image have greater image resolution than the display; the method comprising the steps of:
obtaining the image;
determining an area of importance in the obtained image;
forming an area of importance image containing image information from the area of importance resampled for presentation at the image resolution of the display; and
presenting the area of importance image on the display.

9. The method of claim 8, further comprising the steps of resampling the obtained image to form an evaluation image for presentation at the image resolution of the display and presenting the evaluation image on the display.

10. The method of claim 9, wherein the area of importance appears in greater magnification when the area of importance image is presented than when the evaluation image is presented.

11. The method of claim 8, further comprising the step of presenting an evaluation image for one period of time and wherein the step of presenting the area of importance image comprises presenting the area of importance image for another period of time.

12. The method of claim 11, wherein the evaluation image is presented before the area of importance image.

13. The method of claim 8, wherein a magnification icon is presented overlaying the evaluation image in the area of importance proximate to the presentation of the area of importance image.

14. The method of claim 8, further comprising the steps of detecting an approval signal and storing the archival image in a memory when the approval signal is received.

15. The method of claim 8, wherein the step of obtaining the image comprises capturing the archival image.

16. The method of claim 8, wherein the step of obtaining an image comprises the steps of detecting composition of an archival image, capturing the archival image, and obtaining a set of evaluation images during composition, and wherein the step of determining an area of importance image in the archival image comprises the steps of obtaining an evaluation image corresponding to the archival image comparing the corresponding evaluation image to the sequence of evaluation images to identify common portions of the evaluation images; and generating area of importance data characterizing the portions of the archival image that correspond to the common portions of the evaluation image.

17. A method for using a display having a predetermined image resolution to display an image have greater image resolution than the display; the method comprising the steps of:
obtaining the image;
determining an area of importance in the obtained image;
forming an evaluation image having an appearance that corresponds to the obtained image and is resampled for presentation on the display;
presenting the evaluation image;
forming an area of importance image containing imaging information that corresponds to the area of importance resampled for presentation at the display resolution; and, presenting the area of importance image on the display when an area of importance verification mode is selected.

18. The method of claim 17, wherein an icon is presented indicating when the area of importance image is presented.

19. A method for presenting an area of importance in an image; the method comprising the steps of:
obtaining an archival image;
forming an evaluation image corresponding to the appearance of the archival image and resampled for presentation on the display;
determining an area of importance in the archival image and comprising less than all of the archival image;
displaying an evaluation image that corresponds to the archival image; and
displaying an area of importance image that contains image content the corresponds to the determined area of importance,
wherein the image content of the area of importance as displayed in the area of importance image has a greater effective magnification than the area of importance has as displayed in an evaluation image that corresponds to the archival image.

20. The method of claim 18, wherein the step of determining an area of importance in an archival image comprises the steps of:
detecting composition of an archival image;
capturing the archival image;
obtaining a set of evaluation images during composition;
obtaining an evaluation image corresponding to the archival image comparing the corresponding evaluation image to the sequence of evaluation images to identify common portions of the evaluation images; and
generating area of importance data characterizing the portions of the archival image that correspond to the common portions of the evaluation image.

21. A display device comprising:
a source of an archival image;
a display; and
a processor adapted to determine an area of importance in an archival image, to form an area of importance image that contains less than all of the archival image including image information from the area of importance and that is adapted to be presented on the display, and to cause the display to present the area of importance image.

22. The display device of claim 21, wherein the source of archival images is an image capture system.

23. The display device of claim 21, wherein the archival image comprises at least one of a still image, a motion image, a sequence of still images and a stream of image information.

24. The display device of claim 21, wherein the processor is further adapted to cause the area of importance image to be presented for one period of time and to present an evaluation image that contains image content that corresponds substantially all of the archival image for another period of time.

25. The display device of claim 21, wherein said processor is further adapted to form an evaluation image that contains image content that corresponds to substantially all of the archival image wherein the area of importance image is resampled so that the area of importance appears on the display in greater magnification in the area of importance image than in the evaluation image that contains image content that corresponds to substantially all of the archival image.

26. A display device comprising:
a source of an archival image;
a display;
a signal processor that receives the archival image and that is capable of forming images for presentation on the display based upon the archival image; and
a controller operable to cause the signal processor to form an evaluation image for presentation on the display and to form an area of importance image for presentation on the display,
wherein the evaluation image depicts what is shown in the archival image and the area of importance image depicts only a portion of the archival image that corresponds to the area of importance.

27. The device of claim 26, wherein the controller and signal processor cooperate to form an evaluation image and area of importance image having the substantially similar image size when displayed on the display.

28. The device of claim 26, wherein the area of importance image has a greater effective image magnification than the evaluation image.

29. The display device of claim 26, wherein the controller is operable to automatically cause sequential display of the evaluation image and the area of importance image.

30. The display device of claim 29, wherein the controller is further operable to provide a visual transition between the presentation of the evaluation image and the area of importance image.

31. The display device of claim 33, wherein the transition simulates a zooming effect.

32. The display device of claim 26, wherein the controller further provides a warning when an area of importance image is presented.

33. The display device of claim 26, wherein the controller determines to present at least one of the evaluation image and area of interest image based upon a mode of operation.

34. The display device of claim 26, wherein the controller determines a mode of operation based upon a signal from a transducer in a user input system.

35. The display device of claim 26, wherein the signal processor analyzes the archival image and provides a signal based upon analysis of the archival image and wherein the controller determines a mode of operation based upon the signal.

36. The display device of claim 26, further comprising an image capture system and rangefinder for determining a focus distance for the image capture system, with the rangefinder determining focus distances to a set of areas in a photographic scene and selects the focus distance of one area for focusing the image capture system for obtaining an archival image by way of image capture, wherein the controller and signal processor determine the area of the importance of the archival image by correlating the selected area with the archival image.

37. The display device of claim 26, wherein the area of importance is determined based upon frequency analysis of the data comprises the archival image.

38. The display device of claim 26, wherein the area of importance is determined based upon analysis of illumination patterns in at least one of the scene, the archival image and an evaluation image based upon the archival image.

39. The display device of claim 26, wherein the area of importance is determined by analysis of the scene image information.

40. The display device of claim 26, wherein the area of importance is determined by analysis of at least one of the scene, the archival image and an evaluation image based upon the archival image, to detect the location of preferred image subjects.

41. The display device of claim 26, wherein the area of importance is determined by analysis of at least one of the scene, the archival image and an evaluation image based upon the archival image, to detect the location of faces.

42. The display device of claim 26, wherein the area of importance is determined by analysis of at least one of the scene, the archival image and an evaluation image based upon the archival image, to detect and identify faces.

43. The display device of claim 26, wherein the source of archival images comprises a source of more than one archival image, and wherein the display device is operable to present area of importance images resampled for presentation on the display in a form that occupies less than all of the image resolution of the display so that more than one area of importance image can be viewed on the display at the same time.
